(19) United States
(12) Patent Application Publication
(10) Pub. No.: US 2002/0114156 A1
(43) Pub. Date: Aug. 22, 2002

(54) LIGHT TUBE HOUSING HAVING FACILE INTERCONNECTION WITH ADJACENT HOUSINGS

(76) Inventors: Christopher Wendel, Westfield, NJ (US); Lloyd Harris, Edison, NJ (US)

Correspondence Address: JOSEPH H. ROEDIGER, Ste. 212, 3333 E. Camelback Rd., Phoenix, AZ, 85018, US

(21) Appl. No.: 09/791,009

(22) Filed: Feb. 22, 2001

Related U.S. Application Data
(60) Provisional application No. 60/184,286.

(51) Int. Cl. F21V 23/00

(52) U.S. Cl. 362/221; 362/225; 362/223

(57) ABSTRACT

A housing for a flourescent tube wherein the end caps are formed to interengage the end caps of an adjacent housing thereby enabling the formation of a variable length display panel. A large area advertisement can be removably secured to the panel which provides backlighting. Each end cap is provided with a removable section to permit access to the housing interior and replacement of the flourescent tube or ballast therein.

### CROSS REFERENCE TO RELATED APPLICATION

The present application is based on provisional patent application Serial No. 60/184,286, filed Feb. 23, 2000.

### BACKGROUND OF THE INVENTION

This invention relates to a novel housing structure for a light tube. The structure enables housings to be removably secured one to another for the formation of a lighted display panel.

In the field of display advertising, the use of large area lighted display panels has become commonplace. The display panel is typically comprised of a number of flourescent tubes mounted in a display frame with a display surface that receives the film having the advertisement thereon. The display panel provides the backlighting for the film and aids in creating a strong commercial impression.

The lighted display panel of fixed dimensions has a multitude of uses including stand-alone displays as well as segmented wall displays incorporated in the modular equipment used in exhibitions, conventions and seminars. The fixed dimensions of these panels reduce the flexibility of use. The participants in exhibitions and the like have varying needs dictated by the message to be displayed, the function to be performed in a modular display and the size of the allotted floor space. Thus, the need for lighted displays of variable dimensions is present.

The duration of exhibitions, conventions and seminars is normally quite limited. As a result, the set up and take down of modular walls and associated displays takes place repeatedly. A major goal of the provider of a modular display is to have straight forward assembly routines which can be performed by workers having minimal training. Further, the ability to assemble and disassemble without the need to use elaborate tools is important.

The importance of utilizing a portable display panel that can be free-standing and setup without special tools is recognized in U.S. Pat. No. 3,748,455 to Welton which describes a foldable light box with back supports that open to support the light box in a vertical position. The boxes are attachable at their edges to provide an elongated display. Each box nests with another for stacking in a storage position. An individual box contains a number of flourescent tubes along with the associated electrical equipment. The overall volume and weight of a light box make it difficult to handle and transport.

Another type of display device is disclosed in U.S. Pat. No. 4,864,475 to Jung wherein a rigid light box contains a plurality of horizontal tubes closely positioned to provide a more uniform back lighting for a display. The individual tubes are provided with colored tubing for display purposes. The display device is used for a single display and is not interconnected. The Lotter el al. U.S. Pat. No. 5,301,447 is directed to a rigid light box for housing a lighting module and having a number of flourescent tubes. No provision is made for attaching the light box to adjacent light boxes. The device is constructed for attachment to a standing wall.

A backlighting light fixture which avoids the use of unwieldy, heavy and expensive rigid light boxes is shown in U.S. Pat. No. 5, 584,566 to Bowman et al. A series of interconnected lightweight frames is provided with a plurality of individual transparent of translucent panels. A bowed reflector carrying a flourescent light and ballast is secured to each frame. A reflector is removably attached to each frame section. The use of multiple reflectors for the individual sections of a rigid frame adds time for assembly and results in a multiplicity of parts that need to be handled for shipment to another location. The flourescent tubes are detached from the reflector prior to being stowed.

The above-noted devices are concerned with fixed dimension light boxes or frames. The boxes and frames are stand alone units limiting the ability of the space planner to configure a particular area to the best advantage. The weight, complexity and expense of these units is discussed in the Bowman '566 patent reference.

Accordingly, the present invention is directed to the provision of a flourescent light tube housing that can be readily interconnected with adjacent housings to provide a display of variable length. The housings are secured one to another by end caps which engage to maintain a desired angle therebetween as well as to secure adjacent housings. Thus, the present invention permits the formation of lighted displays of variable shape and length. The ability to assume a variety of shapes makes the present invention substantially more versatile when contrasted with the capability of rigid light boxes.

### SUMMARY OF INVENTION

The present invention is directed to a light tube housing for facile interconnection with adjacent housings to provide the back lighting for a lighted display of variable length and contour.

The novel light tube housing includes a light transmissive tube for containing a flourescent tube. The tube is provided with end caps which are comprised of fixed and removable sections. The fixed sections are securely attached to the tube. Each fixed section and each removable section are semicircular. Each fixed section contains a central stem which nests within the central stem of a removable section. The stems are hollow to receive an electrical socket therein. The flourescent tube is mounted in the sockets. Access to the flourescent tube is provided via the removable section of the upper end cap.

The end caps contain a plurality of outward protrusions radially spaced on the outer surface. The lateral extensions formed by the protrusions provide a peripheral shoulder which contacts the end of the tube and maintains the relative position of end cap and tube. The outer protrusions are provided with first engaging means to secure adjacent housings one to another and to enable a display film to be secured to an array of housings. The region between protuberances is provided with a second engaging means, in the nature of a hook and loop material, to secure adjacent housings.

The protrusions on the end caps register with the regions in between the protrusions on the end cap of an adjacent housing and define the angular relationship therebetween thereby permitting the formation of arrays of different shape and length. A power receptacle is located within the housing to permit electrical interconnection between adjacent housings in an array.

Further features and advantages will become more readily apparent from the following detailed description of a preferred embodiment of the invention when taken in conjunction withe the accompanying drawings.

### BRIEF DESCRIPTION OF THE DRAWINGS

FIG. 1 is a view in perspective showing an array of housings with the display film partially folded back.

FIG. 2 is an exploded view showing the base end cap of the preferred embodiment.

FIG. 3 is an exploded view showing the top end cap of the preferred embodiment.

FIGS. 4A and 4B are side views in section of the end caps taken through the regions between protrusions and through the protrusions respectively.

### DESCRIPTION OF THE PREFERRED EMBODIMENT

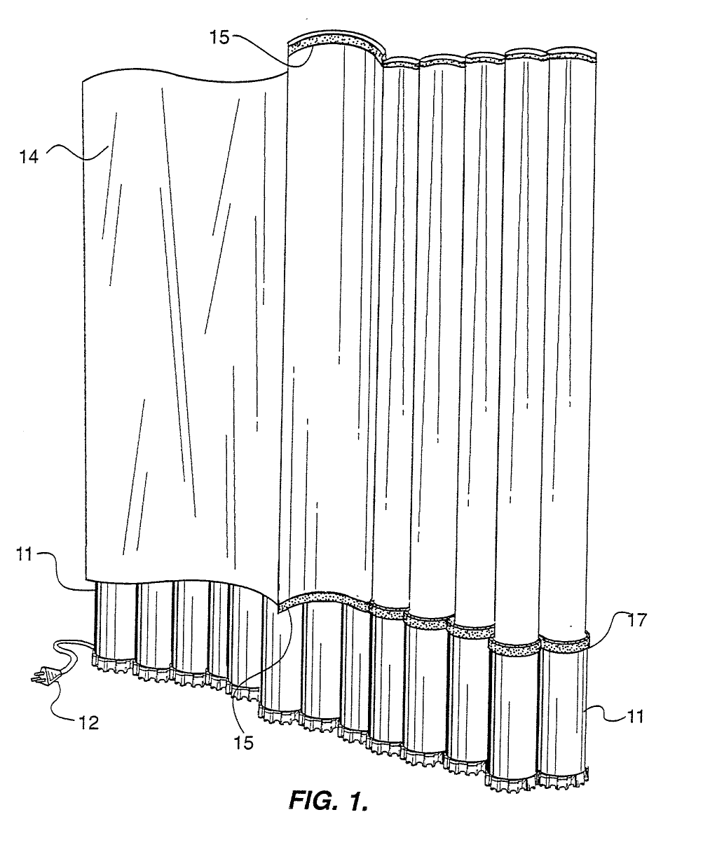

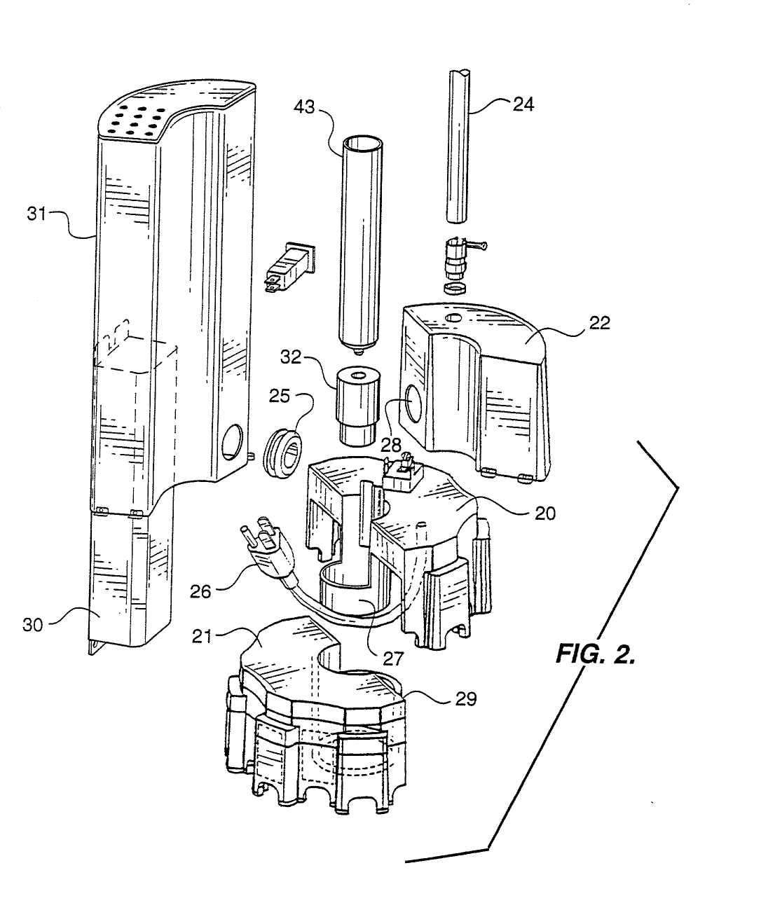

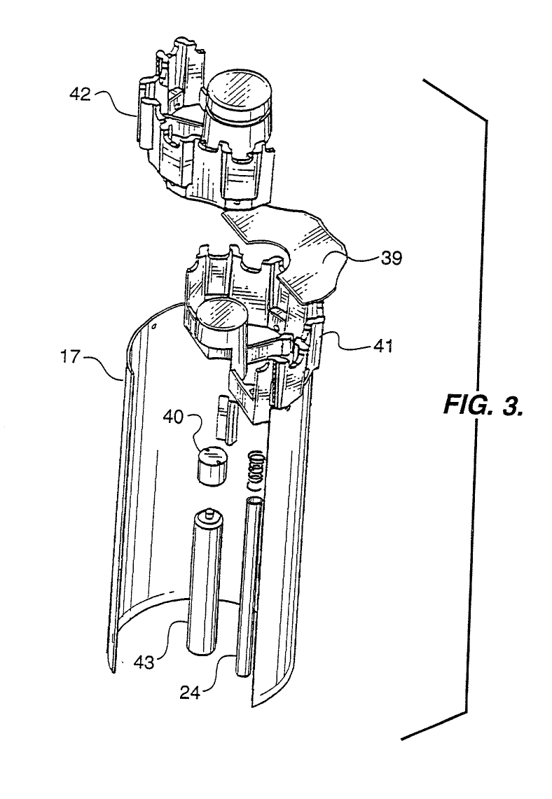

Referring now to FIG. 1, a sinuous array of individual light tube housings 11 is shown with an electrical connector 12 available for connection to an external power source. An overlying film 14 containing the advertising message is shown partially applied to the array. The film 14 is light-transmissive film having bands 15 of hook or loop type fastener located along the top and bottom edges for engagement with mating bands of fasteners located on outward convex protrusions provided on the upper end cap protrusions of the housings and to mating bands of fasteners affixed to the tubular surrounds 17 shown in FIG. 3, near their lower edges. In other embodiments, use is made of fastener bands provided on the base end caps to increase the height of the film affixed to the array. The array of FIG. 1 shows the electrical connections to adjacent housings occurring through openings in the tubular surrounds. As will be noted from the description of the end caps shown in FIGS. 2, 3 and 4, the connections can be provided through notched openings in the protrusions of the bottom end caps.

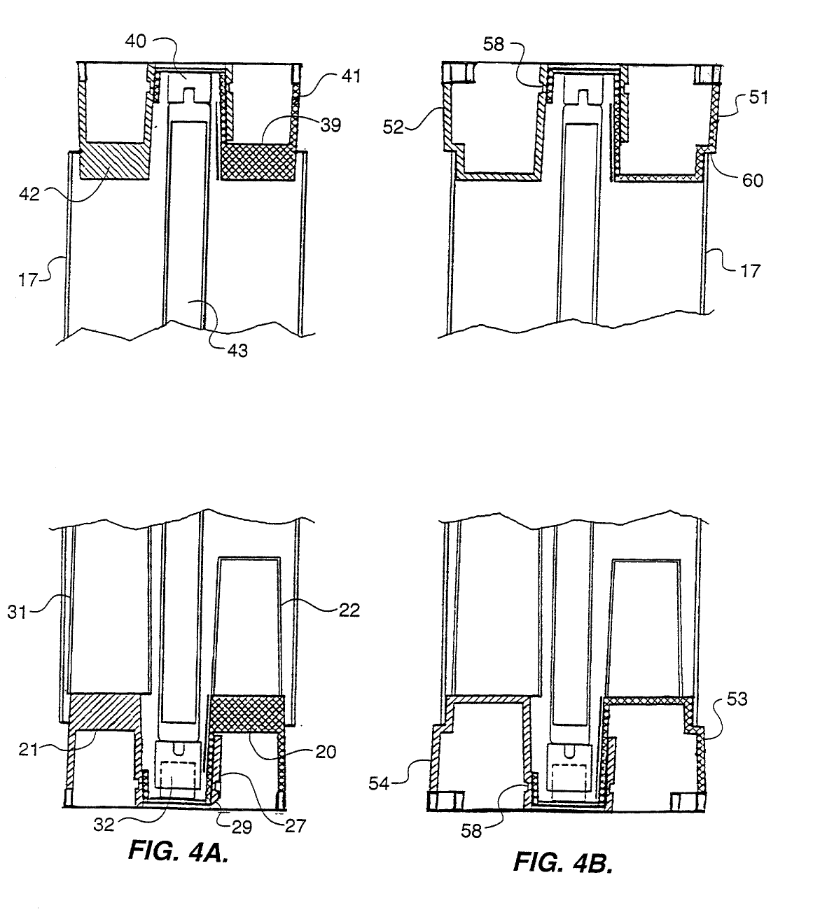

The constructional features of the individual housing are described in connection with the exploded views of the end caps and adjacent components in FIGS. 2 and 3. In the matter of the molded end caps, two segments 20, 21 are formed for both top and bottom of the housing. A fixed or non-removable segment 20 equipped for use as part of a bottom end cap is provided with an electrical housing 22 and affixed thereto by flanges. Conduit 24 is secured at an opening in the top of the housing and extends upwardly to the top end cap of FIG. 3 and spaced in proximity to the light tube to reduce its effect on the transmitted light. The housing 22 contains the receptacle for the electrical connection to an adjacent housing accessible either through the underside of the end cap or a hole in the tubular surround, the external connector 26 for coupling to the next adjacent housing, a circuit breaker and a port 28 which carries the conductors through a like port to ballast 30 contained in housing 31. The ballast housing is affixed to the removable segment 21 of the lower end cap and coupled to housing 22 by a shared grommet 25. Both sections 20, 21 of the end cap are provided with centrally located stems 27, 29 which nest one to another as further shown in the cross sections of FIGS. 4A and 4B. The stem 27 of the fixed segment 20 provides the support for a spring-loaded socket 32, typically fastened by countersinking holes for engagement with the stem. The segments of both top and bottom end caps are connected by threaded fasteners to the adjacent surround and are positionally maintained by the nesting of their respective stems. The outer surface of the stems in the fixed end caps is provided with a circumferential groove 58, seen in FIG. 4B, which receives an o-ring for frictional engagement with a protective cover (not shown).

The top end cap is shown in FIG. 3 wherein a non-spring type socket 40 for a flourescent tube is mounted to the fixed segment 41 of the top end cap. Since conduit 24 terminates at segment 41, a cover plate 39 is provided over the connection to the socket 40 and maintained in position by the stem of the removable segment. The segment 42 is removably attached to the surround and is provided with a central stem that nests on the stem of the fixed segment. A standard flourescent tube 43 is located between the sockets in the stems of the fixed segments of the end caps. Surrounding the tube 43 is a translucent polycarbonate surround or tube 44 which diffuses the light and protects the internal parts in the housing. The surround 44 provides the surface upon which the message film is placed with the flourescent tubes providing the back lighting. Should a tube or ballast need replacement, the removable segment of the top end cap provides access to the interior of the housing.

The top and bottom ends are provided with convex outward protrusions shown as 51 on the fixed segment and 52 on the removable segment of the top end cap. Like protrusions 53 and 54 are provided on the segments of the bottom end cap. The protrusions form shoulders 60 for frictional engagement with the outer tube 44 to enhance the structural rigidity of the housing and aid in alignment of the parts.

The protrusions are used to align adjacent housings to form an array of curved or angular shape. Each protrusion is provided with a region containing a hook or a loop fastener material. The intervening concave regions between the protrusions are provided with the mating fastener material to aid in establishing a locking relationship between adjacent housings. The end caps of adjacent housings serve as toothed gears to define a desired position with the fastener material serving to maintain the position.

The end caps shown have two segments, each having four outward protrusions. In use, at least one protrusion with its fastener surface is in alignment with the display surface of the array. This surface can be utilized to support the planar display material thereon in place of the tubular surrounds. The display material can be installed and removed readily for future use. A substitute display can then be secured on the array without disassembling the array.

In the afore-described embodiment which has been successfully used for a commercial display, the flourescent lamp used is a Type T8 with a polycarbonate surround of 6 inch diameter therearound. The surround length is 91.5 inches and contacts the shoulders of eight protrusions at each end cap. Each shoulder is ¼ inch to accommodate the tube wall of 3/32 inch width.

The end caps are formed of molded plastic with a 3/16 inch thickness. The stems are tapered to facilitate nesting with the outer stem varying from 2 3/16 down to a 2 1/16 inch width. The lamp holder which is commercially available compresses 7/16 inch to permit a ⅜ inch lap pin at top to disengage from the top fixed lamp holder for replacement.

While the foregoing description has been with reference to a particular embodiment of the invention, is to be noted that variations and modifications may be made therein without departing from the scope of the invention.

What is claimed is:

1. A housing for a light tube which comprises:
a) a light transmissive tube having top and bottom openings;
b) a top end cap and a bottom end cap located in the top and bottom openings respectively, each cap having fixed and removable sections, the fixed and removable sections of a cap each having a stem centrally located therein, the stems of adjacent sections being dimensioned for nesting engagement;
C) a plurality of outward protrusions radially located on the outer surface of each cap, said protrusions forming a shoulder for contacting the light transmissive tube;
d) first engaging means located on the outward protrusions of an end cap for coupling the housing to an adjacent housing;
e) top and bottom electrical sockets located in the top and bottom end caps respectively;
f) a light source extending between the sockets; and
g) means for providing electrical power to said light source, the adjacent placement of housings causing the outward protrusions to define the region of attachment therebetween, the engaging means securing adjacent housings one to another.

2. The housing of claim 1 further comprising second engaging means located between the outward protrusions of an end cap for receiving engaging means affixed to an adjacent housing.

3. The housing of claim 2 further comprising an electrical housing mounted on the bottom end cap, said electrical housing containing an electrical receptacle therein for receiving an electric line from an adjacent housing whereby said means for providing power to said light source also provides power to an adjacent housing for a light tube.

4. The housing of claim 3 further comprising a ballast housing mounted on the removable section of the bottom end cap for receiving a ballast for a flourescent tube.

5. The housing of claim 4 further comprising a conduit coupled between the housing and the top fixed end cap for containing an electrical connection between the housing and the top electrical socket.

6. The housing of claim 5 wherein the bottom end cap is provided with notched openings in the protrusions thereof.

7. The housing of claim 6 wherein the protrusions of said end caps are convex.

8. The housing of claim 7 wherein the intermediate regions between the protrusions of said end caps are concave.

9. A plurality of housings as set forth in claim 8 wherein the protrusions and intermediate regions of the end caps of adjacent housings are interengaged to form an array.

10. The array of housings of claim 9 further comprising a light-transmissive film secured to the housings of said array.
